(19) United States
(12) Patent Application Publication
(10) Pub. No.: US 2026/0186899 A1
(43) Pub. Date: Jul. 2, 2026

(54) METADATA SUPPORT FOR DRAM-BASED DATA PROCESSING SYSTEMS

(71) Applicant: Advanced Micro Devices, Inc., Santa Clara, CA (US)

(72) Inventors: Kedarnath Balakrishnan, Bangalore (IN); Ravindra Pannapur, Bangalore (IN); Vilas Sridharan, Brookline, MA (US)

(73) Assignee: Advanced Micro Devices, Inc., Santa Clara, CA (US)

(21) Appl. No.: 19/004,654

(22) Filed: Dec. 30, 2024

(51) Int. Cl. G06F 11/10

(52) U.S. Cl. CPC G06F 11/1044

(57) ABSTRACT

A data processing system includes a memory accessing agent and a memory controller coupled to the memory accessing agent. The memory controller includes an ECC check circuit for detecting errors in a data element and extracting metadata from an error correcting code, in which the detecting and extracting includes forming a plurality of error statuses based on the data element and the error correcting code for different combinations of metadata, and picking a final status and final metadata based on the plurality of error statuses.

### BACKGROUND

Dynamic random-access memory (DRAM) chips are commonly used as main memory in modern data processing systems. DRAMs are based on very small capacitors that store charge to represent a binary logic state. Because of their small size, the charge on these capacitors can be altered when they encounter energetic alpha particles or other electronic effects. In desktop, server, and high-end data center applications, data processing systems commonly provide high-speed memory access time and expandability using DRAM chips combined to form dual-inline memory modules (DIMMs). In order to provide high-reliability, one DIMM configuration adds additional memory chips to store error-correcting codes (ECCs) for the data. A typical double data rate, version five (DDR5) ECC DIMM includes eight memory chips to store the data along with two memory chips for storing the ECCs. The data processor calculates the ECC and stores the data and the ECC on the DIMM. On readback, it re-calculates the ECC for the received data element and compares it to the stored ECC. The data processor detects a data error if the stored ECC does not match the calculated ECC. DRAM ECC operates using symbols. Different symbol widths (×4, ×8, ×16) provide different error correcting and detecting capabilities. ECC symbols are then mapped to actual fault models in the DRAM devices. In addition to enhanced reliability due to the ECC, however, it would be desirable to store certain metadata about the data element, but the cost of yet another memory chip would be high, and supporting yet another memory form factor would be undesirable.

### BRIEF DESCRIPTION OF THE DRAWINGS

FIG. 1 illustrates in block diagram form a data processing system according to some implementations;

FIG. 2 illustrates in block diagram form a memory controller according to some implementations;

FIG. 3 illustrates in block diagram form a data processing system using an error correcting code (ECC) DIMM according to the prior art;

FIG. 4 illustrates in block diagram form an ECC generation and detection system according to the prior art;

FIG. 5 illustrates in block diagram form an ECC generation and detection system with metadata support according to some implementations;

FIG. 6 illustrates in block diagram form an ECC check circuit suitable for use in the ECC check circuit of the memory controller of FIG. 2 according to some implementations; and

FIG. 7 illustrates in block diagram form an optimized form of the ECC check circuit of FIG. 6 according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electronic circuitry, and the description of a block shown in a drawing figure implies the implementation of the described function using suitable electronic circuitry, unless otherwise noted.

### DETAILED DESCRIPTION OF ILLUSTRATIVE IMPLEMENTATIONS

A memory controller, a data processor using such a memory controller, and a method as described herein provide for the storage of metadata in ECC DIMMs by biasing a virtual symbol with metadata bits to generate an error correcting code that can be stored instead of a normal error correcting code. By “piggy-backing” the metadata bits on the ECC code, the error detection efficiency of the ECC is reduced by only a very small percentage.

In particular, an ECC generation circuit builds ECC codes that include virtual symbols and store some information (i.e., metadata) in the virtual symbols. An ECC check circuit can then extract the metadata bits, and process the remaining ECC code as usual. In one aspect, the ECC check circuit includes a set of decoder circuits that correspond to the different combinations of the metadata bits. For example, the combination of two metadata bits can have four combinations, and in general if the number of metadata bits is n, there are 2ⁿ different combinations and 2ⁿ different decoder circuits. The decoder circuits individually determine error statuses assuming the decoder value is the correct value of the metadata added to the virtual symbol. Since only one decoder will extract the correct ECC value, the results can be used to determine the overall error status, and the decoder that stored the correct ECC value, with a high degree of accuracy.

According to another aspect, to avoid the exponential increase in circuit complexity, the ECC check circuit can use logic optimization to decrease the exponential growth to a more linear growth as the number of metadata bits increases. In one example, it does so by generating a base syndrome, and deriving specific syndromes for different combinations of metadata bits that only need to invert specific bits of the base syndrome, which can then be used to determine the type of error. Then error locators for each of the metadata combinations can determine the locations of correctable errors.

A data processing system includes a memory accessing agent and a memory controller coupled to the memory accessing agent. The memory controller includes an ECC check circuit for detecting errors in a data element and extracting metadata from an error correcting code, in which the detecting and extracting includes forming a plurality of error statuses based on the data element and the error correcting code for different combinations of metadata, and picking a final status and final metadata based on the plurality of error statuses.

A memory controller includes an error correcting code (ECC) generation circuit and an ECC check circuit. The ECC generation circuit is operable to bias a virtual symbol based on at least one metadata bit associated with a data element, and to generate an error correcting code in response to the data element and a biased virtual symbol. The ECC check circuit is operable to detect errors in the data element and extract metadata from the error correcting code read from memory by forming a plurality of error statuses based on the data element and the error correcting code for different combinations of metadata, and picking a final status and final metadata based on the plurality of error statuses

A method includes generating an error correcting code for a data element and extracting metadata from the error correcting code. The generating includes biasing a virtual symbol based on at least one metadata bit associated with the data element, and generating the error correcting code in response to the data element and a biased virtual symbol. The extracting includes forming a plurality of error statuses based on the data element and the error correcting code for different combinations of metadata, and picking a final status and final metadata based on the plurality of error statuses

A data processing system, memory controller, and method as described herein allows the storage and extraction of metadata bits by leveraging existing ECC memory. It does so by biasing a virtual symbol according to the metadata bits and using the virtual symbol and the data to form the ECC. The result is that single-error detection and correction capability is preserved, while double error detection efficiency is reduced by only a very small amount. The size of the ECC generation and detection circuits are only increased by a reasonable amount, and through logic optimization, the growth in decoder size as the number of metadata bits increases can be mostly linear.

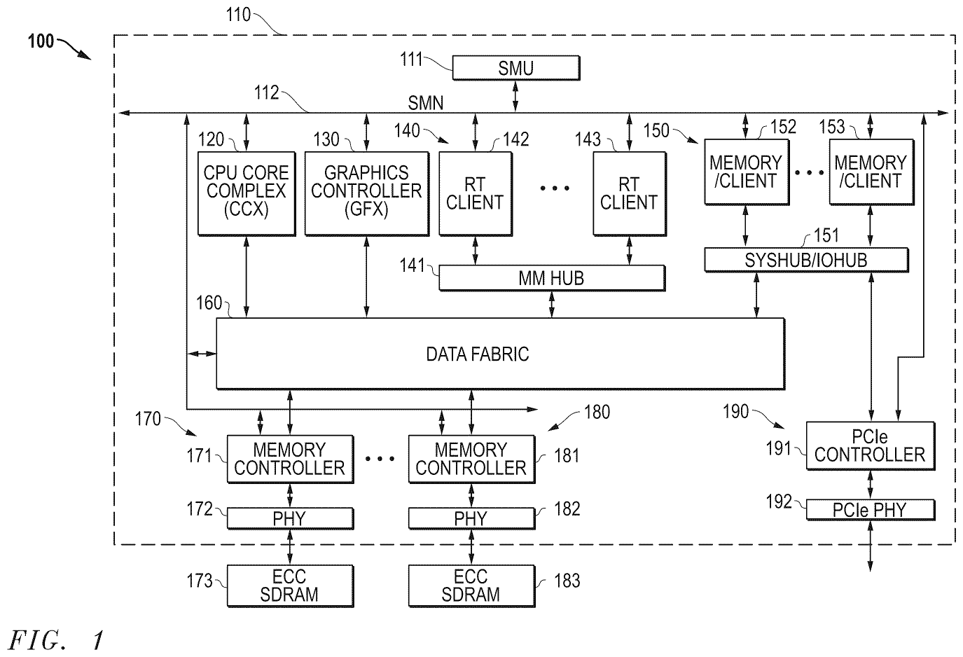

FIG. 1 illustrates in block diagram form a data processing system 100 according to some implementations. Data processing system 100 includes a data processor 110 in the form of an APU and memory in the form of an error correcting code, dual-inline memory module (DIMM) including ECC DIMM 173 and ECC DIMM 183. Many other components of an actual data processing system are typically present but are not relevant to understanding the present disclosure and are not shown in FIG. 1 for ease of illustration.

Data processor 110 includes generally a system management unit 111 labelled “SMU”, a system management network (SMN) 112, a central processing unit (CPU) core complex 120 labeled “CCX”, a graphics controller 130 labeled “GFX”, a real-time client subsystem 140, a memory/client subsystem 150, a data fabric 160, memory channels 170 and 180, and a Peripheral Component Interface Express (PCIe) subsystem 190. As will be appreciated by a person of ordinary skill, data processor 110 may not have all of these elements present in every implementation and, further, may have additional elements included therein.

SMU 111 is bidirectionally connected to the major components in data processor 110 over SMN 112. SMN 112 forms a control fabric for data processor 110. SMU 111 is a local controller that controls the operation of the resources on data processor 110 and synchronizes communication among them. SMU 111 manages power-up sequencing of the various processors on data processor 110 and controls multiple off-chip devices via reset, enable and other signals. SMU 111 includes one or more clock sources (not shown), such as a phase locked loop (PLL), to provide clock signals for each of the components of data processor 110. SMU 111 also manages power for the various processors and other functional blocks, and may receive measured power consumption values from CPU cores in CPU core complex 120 and graphics controller 130 to determine appropriate P-states.

CPU core complex 120 includes a set of CPU cores, each of which is bidirectionally connected to SMU 111 over SMN 112. Each CPU core may be a unitary core only sharing a last-level cache with the other CPU cores, or may be combined with some but not all of the other cores in clusters. CPU core complex 120 is a circuit that operates as a memory accessing agent that initiates and completes memory operations.

Graphics controller 130 is bidirectionally connected to SMU 111 over SMN 112. Graphics controller 130 is a high-performance graphics processing unit capable of performing graphics operations such as vertex processing, fragment processing, shading, texture blending, and the like in a highly integrated and parallel fashion. In order to perform its operations, graphics controller 130 requires periodic access to external memory. In the implementation shown in FIG. 1, graphics controller 130 shares a common memory subsystem with CPU cores in CPU core complex 120, an architecture known as a unified memory architecture. Because data processor 110 includes both a CPU and a GPU, it is also referred to as an accelerated processing unit (APU). Graphics controller 130 is a circuit that operates as a memory accessing agent that initiates and completes memory operations.

Real-time client subsystem 140 includes a set of real-time clients such as representative real time clients 142 and 143, and a memory management hub 141 labeled “MM HUB”. Each real-time client is bidirectionally connected to SMU 111 over SMN 112, and to memory management hub 141. Real-time clients in real-time client subsystem 140 could be any type of peripheral controller that requires periodic movement of data, such as an image signal processor (ISP), an audio coder-decoder (codec), a display controller that renders and rasterizes objects generated by graphics controller 130 for display on a monitor, and the like. Each real-time client is a circuit that operates as a memory accessing agent that initiates and completes memory operations.

Memory/client subsystem 150 includes a set of memory elements or peripheral controllers such as representative memory/client devices 152 and 153, and a system and input/output hub 151 labeled “SYSHUB/IOHUB”. Each memory/client device is bidirectionally connected to SMU 111 over SMN 112, and to system and input/output hub 151. Memory/client devices are circuits that either store data or require access to data on an aperiodic fashion, such as a non-volatile memory, a static random-access memory (SRAM), an external disk controller such as a Serial Advanced Technology Attachment (SATA) interface controller, a universal serial bus (USB) controller, a system management hub, and the like. Each peripheral controller is a circuit that operates as a memory accessing agent that initiates and completes memory operations.

Data fabric 160 is an interconnect that controls the flow of traffic in data processor 110. Data fabric 160 is bidirectionally connected to SMU 111 over SMN 112, and is bidirectionally connected to CPU core complex 120, graphics controller 130, memory management hub 141, system and input/output hub 151. Data fabric 160 includes a crossbar switch for routing memory-mapped access requests and responses between any of the various devices of data processor 110. It includes a system memory map, defined by a basic input/output system (BIOS), for determining destinations of memory accesses based on the system configuration, as well as buffers for each virtual connection.

Memory channels 170 and 180 are circuits that control the transfer of data to and from ECC DIMM 173 and ECC DIMM 183. Memory channel 170 is formed by a memory controller 171 and a physical interface circuit 172 labeled “PHY” connected to ECC DIMM 173. Memory controller 171 is bidirectionally connected to SMU 111 over SMN 112 and has an upstream port bidirectionally connected to data fabric 160, and a downstream port. Physical interface circuit 172 has an upstream port bidirectionally connected to memory controller 171, and a downstream port bidirectionally connected to ECC DIMM 173. Similarly, memory channel 180 is formed by a memory controller 181 and a physical interface circuit 182 connected to ECC DIMM 183. Memory controller 181 is bidirectionally connected to SMU 111 over SMN 112 and has an upstream port bidirectionally connected to data fabric 160, and a downstream port. Physical interface circuit 182 has an upstream port bidirectionally connected to memory controller 181, and a downstream port bidirectionally connected to ECC DIMM 183.

Peripheral Component Interface Express (PCIe) subsystem 190 includes a PCIe controller 191 and a PCIe physical interface circuit 192. PCIe controller 191 is bidirectionally connected to SMU 111 over SMN 112 and has an upstream port bidirectionally connected to system and input/output hub 151, and a downstream port. PCIe physical interface circuit 192 has an upstream port bidirectionally connected to PCIe controller 191, and a downstream port bidirectionally connected to a PCIe fabric, not shown in FIG. 1. PCIe controller is capable of forming a PCIe root complex of a PCIe system for connection to a PCIe network including PCIe switches, routers, and devices.

In operation, data processor 110 integrates a complex assortment of computing and storage devices, including CPU core complex 120 and graphics controller 130, on a single chip. Most of the features of these controllers are well known and will not be discussed further. However, as will be described in greater detail below, data processor 110 includes a memory controller, such as memory controller 171 or memory controller 181, that has an ECC encoding circuit that biases a virtual symbol used in forming the ECC code according to the values of one or more metadata bits, and an ECC decoding circuit that extracts the metadata bits from the ECC code.

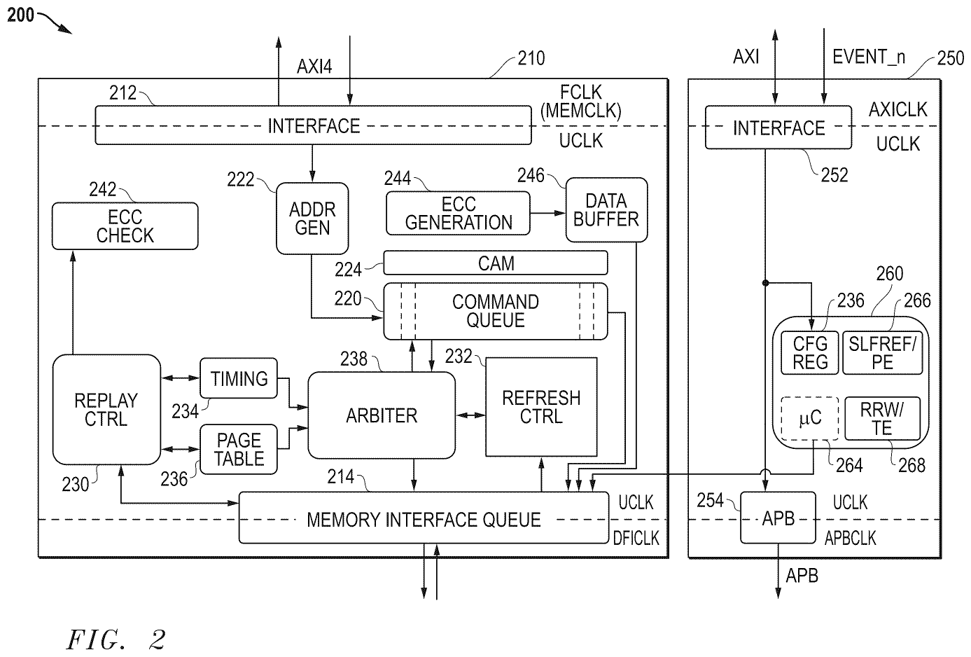

FIG. 2 illustrates in block diagram form a memory controller 200 known in the prior art. Memory controller 200 includes a memory channel controller 210 and a power controller 250. Memory channel controller 210 includes an interface 212, a memory interface queue 214, a command queue 220, an address generator 222, a content addressable memory 224 labelled “CAM”, a replay queue 230, a refresh controller 232, a timing block 234, a page table 236, an arbiter 238, an ECC check circuit 242, an ECC generation circuit 244, and a data buffer 246 labelled “DB”.

Interface 212 has a first bidirectional connection to data fabric 125 over an external bus, and has an output. In memory controller 200, this external bus is compatible with the advanced extensible interface version four specified by ARM Holdings, PLC of Cambridge, England, known as “AXI4”, but can be other types of interfaces in other embodiments. Interface 212 translates memory access requests from a first clock domain known as the FCLK (or MEMCLK) domain to a second clock domain internal to memory controller 200 known as the UCLK domain. Similarly, memory interface queue 214 provides memory accesses from the UCLK domain to the DFICLK domain associated with the DFI interface.

Address generator 222 decodes addresses of memory access requests received from data fabric 125 over the AXI4 bus. The memory access requests include access addresses in the physical address space represented in as a normalized address. Address generator 222 converts the normalized addresses into a format that can be used to address the actual memory devices in the memory system, as well as to efficiently schedule related accesses. This format includes a region identifier that associates the memory access request with a particular rank, a row address, a column address, a bank address, and a bank group. On startup, the system BIOS queries the memory devices in the memory system to determine their size and configuration, and programs a set of configuration registers associated with address generator 222. Address generator 222 uses the configuration stored in the configuration registers to translate the normalized addresses into the appropriate format. Command queue 220 is a queue of memory access requests received from the memory accessing agents in data processor 110, such as CPU core complex 120, graphics controller 130, etc. Command queue 220 stores the address fields decoded by address generator 222 as well other address information that allows arbiter 238 to select memory accesses efficiently, including access type and quality of service (QoS) identifiers. Content addressable memory 224 includes information to enforce ordering rules, such as write after write (WAW) and read after write (RAW) ordering rules.

Replay queue 230 is a temporary queue for storing memory accesses picked by arbiter 238 that are awaiting responses, such as address and command parity responses, write cyclic redundancy check (CRC) responses for DDR4 DRAM or write and read CRC responses for GDDR5 DRAM. Replay queue 230 accesses ECC check circuit 242 to determine whether the returned ECC is correct, whether the ECC indicates a correctable error and ECC check circuit 242 has corrected it, or whether the ECC indicates an uncorrectable error. Replay queue 230 allows the accesses to be replayed in the case of a parity or CRC error of one of these cycles.

Refresh controller 232 is a hardware circuit that includes various circuitry including timers, counters, state machines, registers, digital logic, and the like to implement same bank refresh commands, as well as various powerdown, refresh, and termination resistance (ZQ) calibration cycles that are generated separately from normal read and write memory access requests received from memory accessing agents. For example, if a memory rank is in precharge powerdown, it must be periodically awakened to run refresh cycles. In general, refresh controller 232 generates refresh commands periodically to prevent data errors caused by leaking of charge off storage capacitors of memory cells in DRAM chips. In addition, refresh controller 232 periodically calibrates ZQ to prevent mismatch in on-die termination resistance due to thermal changes in the system. Refresh controller 232 decides when to put DRAM devices in different power down modes.

Refresh controller 232 also has an input connected to command queue 220 and is operable to select an order of providing same bank refresh commands to a set of refresh groups of corresponding banks in the memory based on an aggregate request count of the memory access requests in the command queue. These operations will be described in greater detail below.

Arbiter 238 is bidirectionally connected to command queue 220 and is the heart of memory channel controller 210. It improves efficiency by intelligent scheduling of accesses to improve the usage of the memory bus. Arbiter 238 uses timing block 234 to enforce proper timing relationships by determining whether certain accesses in command queue 220 are eligible for issuance based on DRAM timing parameters. For example, each DRAM has a minimum specified time between activate commands to the same bank, known as “t_{RC}”. Timing block 234 maintains a set of counters that determine eligibility based on this and other timing parameters specified in the JEDEC specification, and is bidirectionally connected to replay queue 230. Page table 236 maintains state information about active pages in each bank and rank of the memory channel for arbiter 238, and is bidirectionally connected to replay queue 230.

In response to read memory access requests received from memory interface queue 214, ECC check circuit 242 extracts the metadata bits from the ECC code and determines whether there is an error in the ECC code, and if the error is a correctable error, to correct the data. ECC check circuit 242 is able to extract the metadata bits, detect and correct single symbol errors in the retuned data and detect but not correct multiple symbol errors with high accuracy.

In response to write memory access requests received from interface 212, ECC generation circuit 244 computes an ECC according to the write data. Data buffer 246 stores the write data and ECC for received memory access requests. It outputs the combined write data/ECC to memory interface queue 214 when arbiter 238 picks the corresponding write access for dispatch to the memory channel.

Power controller 250 includes an interface 252 to an advanced extensible interface, version one (AXI), an APB interface 254, and a power engine 260. Interface 252 has a first bidirectional connection to the SMN, which includes an input for receiving an event signal labeled “EVENT_n” shown separately in FIG. 2, and an output. APB interface 254 has an input connected to the output of interface 252, and an output for connection to a PHY over an APB. Power engine 260 has an input connected to the output of interface 252, and an output connected to an input of memory interface queue 214. Power engine 260 includes a set of configuration registers 262, a microcontroller (μC) 264, a self refresh controller 266 labelled “SLFREF/PE”, and a reliable read/write training engine 268 labelled “RRW/TE”. Configuration registers 262 are programmed over the AXI bus, and store configuration information to control the operation of various blocks in memory controller 200. Accordingly, configuration registers 262 have outputs connected to these blocks that are not shown in detail in FIG. 2. Self refresh controller 266 is an engine that allows the manual generation of refreshes in addition to the automatic generation of refreshes by refresh controller 232. Reliable read/write training engine 268 provides a continuous memory access stream to memory or I/O devices for such purposes as DDR interface read latency training and loopback testing.

Memory channel controller 210 includes circuitry that allows it to pick memory accesses for dispatch to the associated memory channel. In order to make the desired arbitration decisions, address generator 222 decodes the address information into predecoded information including rank, row address, column address, bank address, and bank group in the memory system, and command queue 220 stores the predecoded information. Configuration registers 262 store configuration information to determine how address generator 222 decodes the received address information. Arbiter 238 uses the decoded address information, timing eligibility information indicated by timing block 234, and active page information indicated by page table 236 to efficiently schedule memory accesses while observing other criteria such as QoS requirements. For example, arbiter 238 implements a preference for accesses to open pages to avoid the overhead of precharge and activation commands required to change memory pages, and hides overhead accesses to one bank by interleaving them with read and write accesses to another bank. In particular during normal operation, arbiter 238 may decide to keep pages open in different banks until they are required to be precharged prior to selecting a different page.

FIG. 3 illustrates in block diagram form a data processing system 300 using an error correcting code (ECC) DIMM according to the prior art. Data processing system 300 includes generally a data processor 310, a memory bus 320, and an ECC DIMM 330.

Data processor 310 can be, for example, data processor 110 of FIG. 1 or another data processor having a suitable architecture. Data processor 310 includes an ECC generation circuit 311 and an ECC decode and correction circuit 312. ECC generation circuit 311 has an input for receiving write data, and an output for providing an ECC code as part of a write command. ECC decode and correction circuit 312 has an input for receiving read data and an BCC from ECC DIMM 330, a first output for providing read data, and a second output for providing a status of the data. For example, as shown in FIG. 3, the status could be no error, a correctable error that ECC decode and correction circuit 312 has corrected, an uncorrectable error indicating the detection of a multiple bit error, or a poisoned data element.

Memory bus 320 is a bus that transmits particular signals between data processor 310 and ECC DIMM 330. Most DRAM chips sold today are compatible with various double data rate (DDR) DRAM standards promulgated by the Joint Electron Devices Engineering Council (JEDEC). In the example shown in FIG. 3, the signals are defined by the DDR, version five (DDR5) standard. In this example, the signals include 32 bits of data along with 8 bits of ECC, along with various command and address signals, special control signals, and clock signals as defined by the DDR5 standard.

ECC DIMM 330 has ten by-4 (×4) DDR5 DRAM chips, including exemplary DRAM chips 331-335 that are chips D0, D1, D7, D8, and D9, in which chips D0-D7 store data, and chips D8 and D9 store ECC code. The DRAM chips are connected to a DIMM substrate in which the signals are routed to an edge connector for easy connection to a motherboard or backplane bus.

In operation, the extra two DRAMs provide extra storage for the ECC bits. This level of reliability has been considered to be adequate in many applications such that the ECC DIMM form factor has become popular and widely available at relatively low cost. However, this form factor does not support the storage of separate metadata. Moreover, metadata is typically applied to a whole data element, such as a 256-bit or 512-bit data element that would be read from or written to in a burst of 4 or 8. The cost of adding metadata support would be a significant percentage of the cost of the whole DIMM.

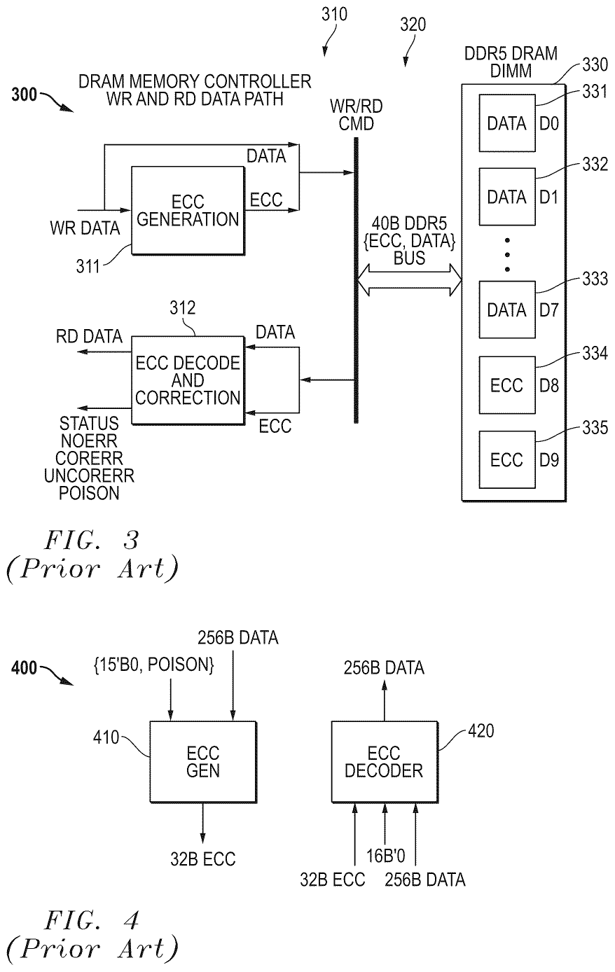

FIG. 4 illustrates in block diagram form an ECC generation and detection system 400 according to the prior art. ECC generation and detection system 400 includes an ECC generator 410 and an ECC decoder 420. ECC generator circuit 410 has a first input for receiving a 16-bit virtual symbol, a second input for receiving a 256-bit data element, and an output for providing a 32-bit ECC. ECC decoder 420 has a first input for receiving a 32-bit ECC, a second input for receiving a virtual symbol, a third input for receiving a 256-bit data element, and an output for providing a corrected 256-bit data element.

ECC generator 410 uses a virtual symbol that has 15 leading zeros in the most significant positions (15b′0), and a bit labelled “POISON” in the least significant bit position. ECC generator 410 generates an ECC code using the virtual symbol to form the 32-bit ECC output. If the data is not poisoned (POISON=0), the virtual symbol has a value of 16b′0. In this case, the virtual symbol does not affect the ECC generation from conventional ECC generation. If the data element is poisoned (POISON=1), the virtual symbol has a value of 16b′1. In this case, the virtual symbol alters the generation of the ECC from conventional ECC generation to guarantee that the memory controller will detect a multiple-bit error and generate an exception to indicate a serious system error.

ECC decoder 420 re-creates the ECC based on the baseline virtual symbol of 16b′0. If the data is not poisoned (POISON=0), the re-created ECC will match the received 32-bit ECC. If the data is poisoned (POISON=1), the re-created ECC will not match the received 32-bit ECC and ECC decoder 420 will detect an uncorrectable error. As used in this context, “poisoned” data means that the data is known to have an error that cannot be corrected. This result ensures that poisoned data is not used. In response to the uncorrectable error, a memory controller can generate an exception that will take appropriate remedial action, such as terminating an existing process or program. Thus, the virtual symbol has two possible values, indicating the value of the POISON bit.

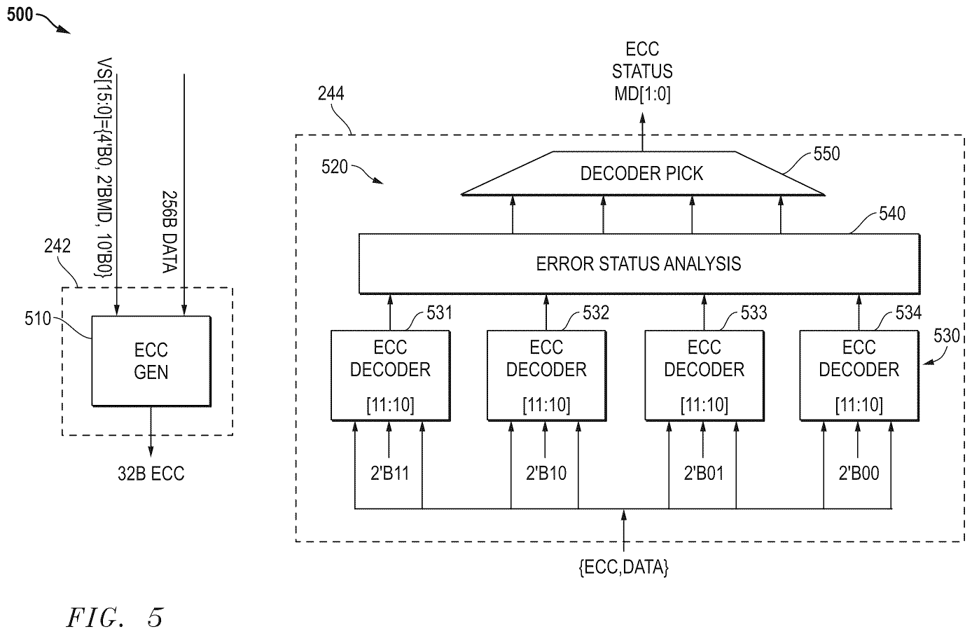

FIG. 5 illustrates in block diagram form an ECC generation and detection circuit 500 with metadata support according to some implementations. ECC generation and detection circuit 500 includes an ECC generator 510 (corresponding to ECC check circuit 242 of FIG. 2) and an ECC decoder 520 (corresponding to ECC generation circuit 244 of FIG. 2).

ECC generator 510 uses a virtual symbol labelled “VS” that has 4 leading zeros in the most significant positions (4b′0), two metadata bits in the next two most significant bit positions (2b′MD), and 10 trailing zeros in the least significant bit positions (10b′0). ECC generator 410 generates an SECDED code using the virtual symbol to form the 32-bit ECC output. The metadata bits replace 0s of the VS in bit positions 11 and 10 as will be described further below.

ECC decoder 520 has a first input for receiving a 32-bit ECC, a second input for receiving a 256-bit data element, and an output for providing an ECC status and a recovered metadata labelled “MD[1:0]”. ECC decoder 520 includes generally a metadata decoder stage 530, an error status analysis circuit 540, and a decoder pick circuit 550.

Metadata decoder stage 530 includes a set of decoders 531, 532, 533, and 534. Decoder 531 has a first input for receiving a 32-bit ECC, a second input for receiving two metadata bits with values of 1 (2b′11) mapped to bit positions 11 and 10 of the VS, a third input for receiving the 256-bit data element, and an output for providing a corresponding syndrome and a corresponding error locator. Decoder 532 has a first input for receiving the 32-bit ECC, a second input for receiving two metadata bits with values of 1 and 0 (2b′10) mapped to bit positions 11 and 10, respectively, of the VS, a third input for receiving the 256-bit data element, and an output for providing a corresponding syndrome and a corresponding error locator. Decoder 533 has a first input for receiving the 32-bit ECC, a second input for receiving two metadata bits with values of 0 and 1 (2b′01) mapped to bit positions 11 and 10, respectively, of the VS, a third input for receiving the 256-bit data element, and an output for providing a corresponding a corresponding syndrome and a corresponding error locator. Decoder 534 has a first input for receiving the 32-bit ECC, a second input for receiving two metadata bits with values of 0 (2b′00) mapped to bit positions 11 and 10, respectively, of the VS, a third input for receiving the 256-bit data element, and an output for providing a corresponding syndrome and a corresponding error locator.

Error status analysis circuit 540 has four inputs receiving the corresponding syndrome and the corresponding error locator from each of the corresponding metadata decoder stages, and four outputs for providing corresponding error statuses. Each error status indicates whether there is no error, whether there is a correctable error, and whether there is an uncorrectable error for each corresponding metadata combination.

Decoder pick circuit 550 has four inputs for receiving the corresponding syndrome and corresponding error locator for each metadata combination, and an output for providing the ECC status and the recovered metadata combination MD[1:0].

In operation, each decoder circuit of metadata decoder stage 530 inserts a respective one of the different metadata combinations into corresponding bit positions [11:10] of the virtual symbol, and uses the modified virtual symbol to re-generate the ECC for the received data. It outputs an error syndrome (“S”) and an error locator (“L”) for each metadata combination.

Error status analysis circuit 540 operates as follows. Overall, it analyzes the syndrome and error locator values to determine the status of each possible metadata combination. If S=0, then there was no error (“NE”). If S=1 but L=0, there was an uncorrectable error (“UE”). If S=0 and L≠0, then there was a correctable, single-bit error (“CE”), and the S and L bits can be used to locate the error and make the correction to form corrected data.

Decoder pick circuit 550 determines a final error status and picks a decoded metadata value in response to the error status of each of the different combinations of metadata, in which the final error status is inferred as the correct status based on the individual statuses for each metadata combination. TABLE I below shows the operation of decoder pick circuit 550:

TABLE I

| Error Type | Decoder Results | Decoder Pick |
|---|---|---|
| No Error | 1 - No error | Decoder that reported |
| | 3 - correctable error in VS | no error |
| Single Symbol | 1 - correctable error in non-VS | Correctable error |
| Error | 3 - uncorrectable error | decoder |
| Single Symbol | 2 - correctable error | No decoder picked |
| Error | 2 - uncorrectable error | |
| Others | Other combinations | No decoder picked |

At most, one decoder circuit will be correct. Each decoder circuit then checks the regenerated ECC against the received ECC to determine whether there was an error. If there was no error in the accessed data, and the metadata combination is the same as the metadata that is was inserted into the virtual symbol, then the corresponding decoder will indicate no error, while the other decoders will indicate errors according to whether an error existed in the data. Decoder pick circuit 550 operates as follows. If there was no actual error in the data, then the decoder in which the received ECC matches the generated ECC indicates the value of the recovered metadata, while all other decoders will indicate single-bit errors due to having incorrect data from their virtual symbols. In this case, decoder pick circuit 550 picks the decoder that reported no error to provide the data and reports no error (NE).

If there was a single symbol error that occurred in a position other than the virtual symbol, i.e., in either the Data or the ECC, then decoder pick circuit 550 picks the decoder with the one metadata bit combination with a correctable error (CE).

If there was a single symbol error in which two decoders indicated a correctable error, then the error was caused by the limitations of the ECC code. If there was no actual error in the data, then the decoder in which the received ECC matches the generated ECC indicates the value of the recovered metadata, while all other decoders will indicate single-bit errors due to having incorrect ECCs. In this case, decoder pick circuit 550 reports no error, and picks the decoder that reported no error to provide the data. Since both decoders returned a correctable error, no decoder is picked at this stage and decoder pick circuit 550 marks the result as an uncorrectable error (UE). There are some larger data element use cases, described more fully below, in which this result can be decoded.

All other combinations cause decoder pick circuit 630 to pick no decoder and to mark the result as an uncorrectable error (UE).

As shown in FIG. 5, the use of two metadata bits required the use of four decoder circuits. As the number of metadata bits increases, the raw complexity of the ECC decoder circuits will increase by a factor of 2ⁿ, in which n is the number of metadata bits. In order to prevent the exponential growth in the number of metadata decoder circuits and circuit area, the inventor has discovered that the growth rate of the hardware can be limited to something closer to a linear progression. These implementations are formed using optimized logic circuits, i.e., circuits that uses Boolean logic optimization techniques to reduce the unique circuitry for the different input combinations, and to share common circuitry between multiple decoding paths. An example of an optimized-logic ECC decoder circuit will now be described.

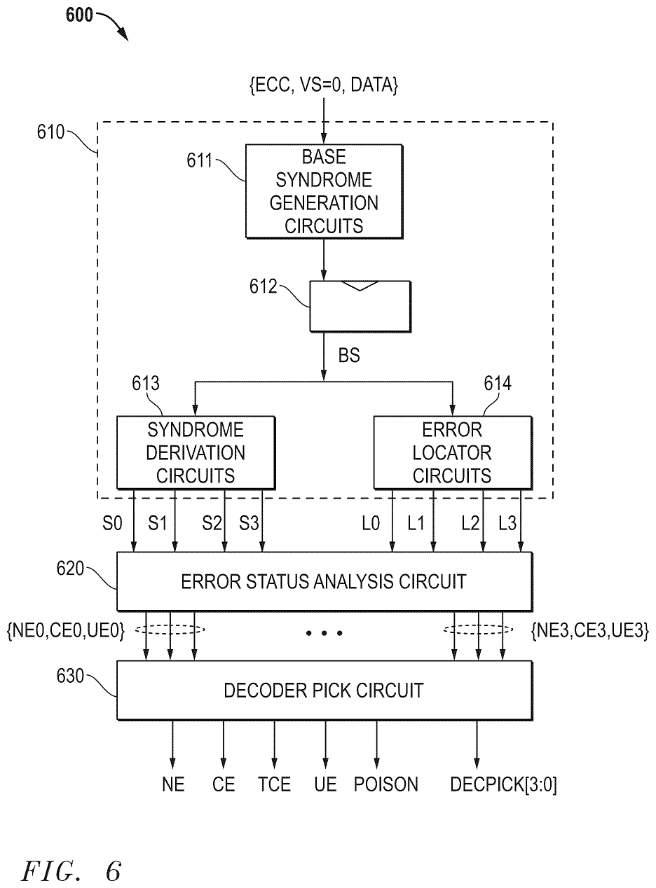

FIG. 6 illustrates in block diagram form an ECC check circuit 600 suitable for use in ECC check circuit 242 of the memory controller of FIG. 2 according to some implementations. ECC check circuit 600 shows the example of an optimized-logic decoder circuit for the case of two metadata bits, but this technique will be useful in constraining the growth of integrated circuit area as the number of metadata bits grows to larger numbers. ECC check circuit 600 includes generally an optimized-logic decoder circuit 610, an error status analysis circuit 620, and a decoder pick circuit 630.

Optimized-logic decoder circuit 610 includes a base syndrome generation circuit 611, a latch 612, a set of syndrome derivation circuits 613, and a set of error locator circuits 614. Base syndrome generation circuit 611 has a first input for receiving an ECC, a second input for receiving a base virtual syndrome of b0, a third input for receiving the corresponding data, and an output for providing a base syndrome. Latch 612 has an input connected to the output of base syndrome generation circuit 611, a clock input for receiving a suitable clock signal, and an output for providing a base syndrome labelled “BS”, and a control input for receiving a latch enable signal, in which base syndrome BS is obtained by multiplying a parity check matrix with a set of incoming data and ECC bits. The latch enable signal is a signal that captures the output of base syndrome generation circuit 611 after it has had enough time to resolve. Syndrome derivation circuits 613 have an input connected to the output of latch 612 for receiving the BS, and outputs for providing metadata-specific syndromes S0, S1, S2, and S3 that are formed by inverting specific bits of the BS and keeping other bits unaltered. Error locator circuits 614 have an input connected to the output of latch 612 for receiving the BS, and outputs for providing error locators L0, L1, L2, and L3.

Error status analysis circuit 620 has four inputs receiving the corresponding syndrome and the corresponding error locator from each of the corresponding metadata decoder stages, and four outputs for providing corresponding error statuses. Each error status indicates whether there is no error (“NE”), whether there is a correctable error (“CE”), and whether there is an uncorrectable error (“UE”) for each corresponding metadata combination. An optimized-logic version of error status analysis circuit 620 is shown further below.

Decoder pick circuit 630 has four inputs for receiving the corresponding syndrome and corresponding error locator for each metadata combination, and outputs for providing the ECC status and the recovered metadata combination MD[1:0]. An optimized-logic version of decoder pick circuit 630 is shown further below.

Optimized-logic decoder circuit 610 leverages the observation that each individual syndrome is equal to the base syndrome with only a few bits inverted from the base syndrome for each individual syndrome. For example, S0 (MD[1:0]=00) is equal to the base syndrome; S1 (MD[1:0]=01) is equal to the base syndrome with bits 10, 16, 18, 19, 21, 23, 24, 26, 27, 28, 29, and 31 inverted; S2 (MD[1:0]=10) is equal to the base syndrome with bits 11, 16, 17, 19, 22, 24, 25, 27, 28, 30, and 31 inverted; and S3 is equal to the base syndrome with bits 10, 11, 17, 18, 21, 22, 23, 25, 26, 29, 30 inverted.

What has been described so far is a system that “piggy backs” metadata onto an ECC using a virtual symbol that biases the ECC and is sent to ECC memory during a read cycle, and is decoded when the data and ECC are read during a write cycle. A memory controller coupled to a memory accessing agent and includes an ECC check circuit for detecting errors in and extracting metadata from a data element and an error correcting code. The detecting includes forming a plurality of error statuses based on the data element and the error correcting code for different combinations of metadata, and picking a final status and final metadata based on the plurality of error statuses. For example, for the predominant case of no error, the decoder with the correct metadata will report no errors, while the other decoders will report a single bit error from the incorrect metadata. The other error cases can be determined from the combinations of statuses, which allows the detection and correction of single-bit errors. In this baseline example of using two metadata bits for 16 bits of ECC protecting 128 bits of data using 16-bit virtual symbols, the prediction rate is 100% for single bit errors, and 94-95% for multiple-bit errors.

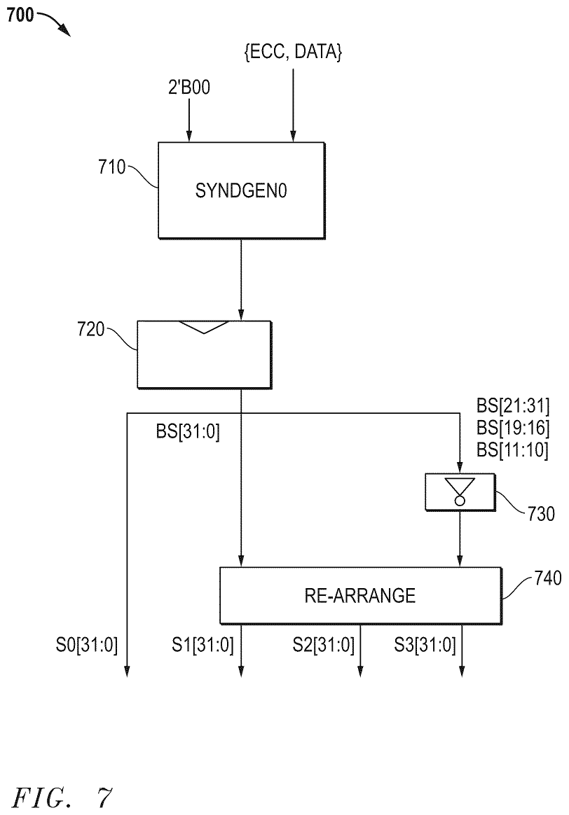

This basic system forms the baseline implementation that can be varied. For example, the simple system of using a 16-bit biased ECC code for 128 bits of data can be expanded to cover a 32-bit ECC for 256 bits of data. In this implementation, known as “full ECC”, a full line can be broken into different ECC words in which the ECC is generated separately. In one example, an 80b DIMM has two 40-bit sub-channels, in which each sub-channel has ten by-four memories, in which two are for ECC and the other eight are for data. In another example, a 72b DIMM has two 36-bit sub-channels, in which each sub-channel has nine by-four memories, in which one is for ECC and the other eight are for data. A separate ECC can be calculated for each 128-bit half, while the same metadata is used for each half to bias 16-bit virtual symbols in the manner described above. A decoder as in FIG. 5 or an optimized decoder as in FIG. 6 can be used for each half, or the same decoder can be used for each half in a time-multiplexed fashion, with different data and ECC but the same metadata combinations. Since the same metadata is used to bias the virtual symbol for both halves, the decoders picked in each half should match, unless there is an error in the ECC itself. The final error status and metadata can be determined by looking at both halves using a voting system. Using this voting system, errors can be detected by forming a plurality of error statuses based on the data element and the error correcting code for different combinations of metadata for each ECC word and each decoder, and a final status and final metadata can be picked based on the error statuses formed as a result of the voting process. For example, if the metadata bit combination is “01” and the ECC decoder corresponding to the “01” metadata combination in each ECC word detects no error, then the decoded metadata is “01” and no error correction is necessary. If only one of the “01” ECC decoders detects an error while the other one detects no error, then “01” is the correct metadata, and the ECC decoder with the error can use the ECC bits to correct the data. Other combinations of outcomes can provide correct extraction of the metadata and appropriate error correction to correct errors in the data. FIG. 7 illustrates in block diagram form an optimized ECC check circuit 700 according to some implementations. ECC check circuit 700 applies logic optimization to ECC check circuit 600 of FIG. 6 while performing the same overall function. ECC check circuit 700 includes a syndrome generator 710, a latch circuit 720, a selective inversion circuit 730, and a bit re-arrangement circuit 740. Syndrome generator 710 has inputs for receiving an ECC, a data element, and a virtual symbol having a value of 2b′00, and an output for providing a base symbol labelled “BS[31:0]”. Latch 710 latches the base symbol in response to a suitable clock signal. Selective inversion circuit 730 inverts certain bits of the base syndrome that will be used in the generation of specific syndromes for each metadata bit combination, including bits 21-31, 16-19, and 11 and 10.

Bit re-arrangement circuit 740 uses certain original bits with other inverted bits to form the S1, S2, and S3 syndromes. Note that bits 11 and 10 of the virtual symbol only affect some of the bits. In particular, virtual symbol bit 11 affects only bits 11, 16, 17, 19, 22, 24, 25, 27, 28, 30, and 31 of the syndrome, whereas virtual symbol bit 10 affects only bits 10, 16, 18, 19, 21, 23, 24, 26, 27, 28, 29, and 31 of the syndrome. Syndromes S0 to S4 are generated as in equations [1]-[4] below:

$$S 0 = BS [ 31 : 0 ] \qquad [ 1 ]$$

$$S 1 = BS [ 31 : 0 ] with bits 10 , 16 , 18 , 19 , 21 , 23 , 24 , 26 , 27 , 28 , 29 , 31 inverted \qquad [ 2 ]$$

$$S 2 = BS [ 31 : 0 ] with bits 11 , 16 , 17 , 19 , 22 , 24 , 25 , 27 , 28 , 30 , 31 inverted \qquad [ 3 ]$$

$$S 3 = BS [ 31 : 0 ] with bits 10 , 11 , 17 , 18 , 21 , 22 , 23 , 25 , 26 , 29 , 30 inverted \qquad [ 4 ]$$

By using digital logic optimization, which includes sharing logic terms among circuits, ECC check circuit 700 performs the function of syndrome derivation circuits 613 of FIG. 6, but prevents the exponential increase in circuit area with the increase in the number of metadata bits, allowing more metadata bits to be implemented in a practical implementation.

These techniques can also be applied to the error locator circuit. Again, assuming two metadata bits, first the base syndrome BS[31:0] is generated. Then four individual error locators are formed corresponding to each virtual symbol. Based on finding a correctable error, then the error locator corresponding to the picked virtual symbol will be used to locate and correct the single bit error in the data.

Thus, a data processing system, memory controller, and method have been described that can be used to provide the capability of storing metadata in a system that uses conventional ECC DIMMs. A write operation includes biasing a virtual symbol based on the metadata bits, forming an ECC based on the data and the virtual symbol, and storing the ECC in memory, such as in a sideband ECC such as an ECC DIMM. During a read cycle, the data and the ECC are read from memory. The ECC is regenerated in the memory controller by extracting the metadata by forming a plurality of error statuses based on the data element and the error correcting code for different combinations of metadata, and picking a final status and final metadata based on the plurality of error statuses.

For example, if the generated ECC matches the received ECC of a particular value of metadata, then that value of the metadata is the correct metadata. If there is a single bit error in the data or in the ECC, then the data can be corrected. In some implementations, a biased ECC can be based on a larger data element, in which the ECC is calculated for a portion of the data element but the metadata is the same for each portion of the data element. In this case, a voting process can be applied to the results of checking the ECC for each portion of the larger data element to determine whether the data can be corrected, or the errors cause an uncorrectable error. In this case, the voting process allows certain situations with two correctable errors in each portion can allow the extraction of the correct data and metadata. In any case, single-bit error correction capability remains at 100%, and multiple error detection capability only reduces by a very small amount for small amounts of metadata.

While particular implementations have been described, various modifications of these implementations will be apparent to those skilled in the art. For example, the number of metadata bits can vary in different implementations. The metadata bits themselves can also support various functions, such as poison, security settings, routing paths through various data processor components, and the like. The technique described above is useful irrespective of the specific ECC code used, as long as there is a space for the virtual symbol. The technique can be applied to different sizes of data elements, for example a 16-bit ECC for a 128-bit data element, and different ECCs can be used. Also in particular practical implementations, various features and capabilities can be enabled by the user such as basic ECC or full ECC with voting. Also, the use of ECC can be disabled such that the memory controller can be used with either simple DIMMs or ECC DIMMs.

Accordingly, it is intended by the appended claims to cover all modifications of the disclosed implementations that fall within the scope of the disclosed implementations.

What is claimed is:

1. A data processing system comprising:
a memory accessing agent; and
a memory controller coupled to the memory accessing agent and comprising an error correcting code (ECC) check circuit for detecting errors in a data element and extracting metadata from an error correcting code, the detecting and extracting comprising forming a plurality of error statuses based on the data element and the error correcting code for different combinations of metadata, and picking a final status and final metadata based on the plurality of error statuses.

2. The data processing system of claim 1, wherein the memory controller further comprises:
an ECC generation circuit operable to bias a virtual symbol based on at least one metadata bit, and to generate a corresponding error correcting code in response to the data element and a biased virtual symbol.

3. The data processing system of claim 1, wherein ECC check circuit comprises:
a plurality of decoder circuits for each of the different combinations of metadata, each having a first input for receiving the data element, a second input for receiving a corresponding one of a plurality of metadata states, a third input for receiving a corresponding error correcting code, and an output for providing an error syndrome and a corresponding error locator.

4. The data processing system of claim 1, wherein the ECC check circuit comprises:
an optimized-logic decoder circuit.

5. The data processing system of claim 4, wherein the optimized-logic decoder circuit comprises:
a base syndrome generation circuit for providing a base syndrome in response to a corresponding error correcting code and the data element;
a plurality of syndrome derivation circuits for inverting predetermined bits of the base syndrome corresponding to each of the different combinations of metadata while keeping other bits un-inverted, and forming metadata-specific syndromes in response thereto; and
a plurality of error locator circuits for providing a bit number of error bits for corresponding ones of the different combinations of metadata in response to corresponding metadata-specific syndromes and the data element.

6. The data processing system of claim 3, wherein the ECC check circuit further comprises:
an error status analysis circuit, for reporting an error status of each of the different combinations of metadata as one of: no error, a correctable error, and an uncorrectable error; and
a decoder pick circuit, for determining a final error status and picking a decoded metadata value in response to the error status of each of the different combinations of metadata.

7. The data processing system of claim 6, wherein the ECC check circuit further comprises:
a data correction circuit for generating corrected data based on the data element and an error locator corresponding to the decoded metadata value when the final error status indicates a correctable error.

8. The data processing system of claim 1, wherein the data element comprises a plurality of data sub-elements, and the ECC check circuit detects errors in and extracts metadata from the plurality of data sub-elements and a corresponding plurality of error correcting codes for the different combinations of metadata, and picks the final status and the final metadata based on the plurality of error statuses using a voting process.

9. The data processing system of claim 1, further comprising:
a memory coupled to the memory controller, wherein the memory stores the data element and the error correcting code.

10. A memory controller comprising:
an error correcting code (ECC) generation circuit operable to bias a virtual symbol based on at least one metadata bit associated with a data element, and to generate an error correcting code in response to the data element and a biased virtual symbol; and
an ECC check circuit operable to detect errors in the data element and extract metadata from the error correcting code read from memory by forming a plurality of error statuses based on the data element and the error correcting code for different combinations of metadata, and picking a final status and final metadata based on the plurality of error statuses.

11. The memory controller of claim 10, further comprising:
a command queue for storing memory access requests, the memory access requests including read requests and write requests; and
an arbiter for picking memory commands from among the memory access requests for dispatch to the memory,
wherein in response to picking a write memory access request, the arbiter activates the ECC generation circuit to generate the error correcting code in response to the data element and the biased virtual symbol, and
wherein in response to picking a read memory access request, the arbiter activates the ECC check circuit to generate the error correcting code and to extract the metadata bit in response to the data element and the biased virtual symbol.

12. The memory controller of claim 11, wherein the ECC check circuit comprises:
a plurality of decoder circuits for each of the different combinations of metadata, each having a first input for receiving the data element, a second input for receiving a corresponding one of a plurality of metadata states, a third input for receiving the error correcting code, and an output for providing an error syndrome and a corresponding error locator.

13. The memory controller of claim 11, wherein the ECC check circuit comprises:
an optimized-logic decoder circuit.

14. The memory controller of claim 13, wherein the optimized-logic decoder circuit comprises:
a base syndrome generation circuit for providing a base syndrome in response to the error correcting code and the data element;
a plurality of syndrome derivation circuits for inverting predetermined bits of the base syndrome corresponding to each of the different combinations of metadata while keeping other bits un-inverted, and forming metadata-specific syndromes in response thereto; and
a plurality of error locator circuits for providing a bit number of error bits for corresponding ones of the different combinations of metadata in response to corresponding metadata-specific syndromes and the data element.

15. The memory controller of claim 12, wherein the ECC check circuit further comprises:
an error status analysis circuit, for reporting an error status of each of the different combinations of metadata as one of: no error, a correctable error, and an uncorrectable error; and
a decoder pick circuit, for determining a final error status and picking a decoded metadata value in response to the error status of each of the different combinations of metadata.

16. The memory controller of claim 15, wherein the ECC check circuit further comprises:
a data correction circuit for generating corrected data based on the data element and an error locator corresponding to the decoded metadata value when the final error status indicates a correctable error.

17. The memory controller of claim 12, wherein the data element comprises a plurality of data sub-elements, and the ECC check circuit detects errors in and extracts metadata from the plurality of data sub-elements and a corresponding plurality of error correcting codes for the different combinations of metadata, and picks the final status and the final metadata based on the plurality of error statuses using a voting process.

18. A method comprising:
generating an error correcting code for a data element, comprising:
biasing a virtual symbol based on at least one metadata bit associated with the data element, and
generating the error correcting code in response to the data element and a biased virtual symbol; and
extracting metadata from the error correcting code, comprising:
forming a plurality of error statuses based on the data element and the error correcting code for different combinations of metadata; and
picking a final status and final metadata based on the plurality of error statuses.

19. The method of claim 18, further comprising:
writing the data element and the error correcting code to a memory in response to a write command; and
reading the data element and the error correcting code from the memory in response to a read command.

20. The method of claim 18, further comprising:
decoding each of the different combinations of metadata in a plurality of decoder circuits, each having a first input for receiving the data element, a second input for receiving a corresponding one of a plurality of metadata states, a third input for receiving the error correcting code, and an output for providing an error syndrome and a corresponding error locator.
